(19) United States
(12) Patent Application Publication
(10) Pub. No.: US 2014/0083184 A1
(43) Pub. Date: Mar. 27, 2014

(54) Tracking taking account of a linear relationship

(71) Applicant: VEGA Grieshaber KG, Wolfach (DE)

(72) Inventors: Roland WELLE, Hausach (DE); Christian HOFERER, Offenburg (DE)

(73) Assignee: VEGA Grieshaber KG, Wolfach (DE)

(21) Appl. No.: 13/932,731

(22) Filed: Jul. 1, 2013

Related U.S. Application Data
(63) Continuation of application No. PCT/EP2012/064740, filed on Jul. 26, 2012.
(60) Provisional application No. 61/676,022, filed on Jul. 26, 2012.

(51) Int. Cl. G01F 23/28

(52) U.S. Cl. CPC G01F 23/28
USPC 73/290 V

(57) ABSTRACT

In accordance with one aspect of the invention, previously obtained findings concerning the role of individual echoes are taken into account, so as to improve the continued following of these echoes by tracking. By calculating a linear correspondence between two tracks, the expected position of an echo can be determined and it can be established whether this position corresponds to an actual echo position in the echo curve.

### FIELD OF THE INVENTION

The invention relates to the technical field of fill level measurement. In particular, the invention relates to a delay-based fill level measurement device, to a method for carrying out a tracking method using a fill level measurement device, to a processor, to a computer-readable medium and to a program element.

### TECHNICAL BACKGROUND

Delay-based fill level measurement devices work by FMCW or pulse delay, i.e. a FMCW or pulse run-time method. These measurement devices emit electromagnetic or acoustic waves towards a filling material surface. These waves are subsequently reflected in whole or in part from various reflectors. These reflectors may in particular be the surface of the filling medium (for example water, oil, other fluids or fluid mixtures or bulk material), the base of the container in which the filling medium is stored, impurities, separating layers between different filling materials (for example the separating layer between water and oil) or stationary interference points in the container, such as projections or other container fixtures.

The transmission signal which is reflected in this manner (also referred to in the following as the reception signal or echo curve) is subsequently received and recorded by the fill level measurement device.

Fill level measurement devices typically work in pulsed operation, that is to say they emit a respective transmission signal in pulsed form at various times, and the resulting reflected pulse of the transmission signal (reception signal) is subsequently, as disclosed above, detected by the sensor system of the fill level measurement device. From this, the evaluation unit of the device subsequently derives the location or position of the filling medium surface. Thus, in other words, the fill level is determined from this received pulse.

Other fill level measurement devices work by FMCW. In this case, frequency-modulated waves are continuously radiated towards the container, and the reflected signal components are processed in the device together with the instantaneously radiated signal. This processing results in a frequency spectrum which can be converted into an echo curve by known methods.

The data which are thus obtained, which may already have been processed and evaluated, can be supplied to an external device. They may be provided in analogue form (4 . . . 20 mA interface) or in digital form (field bus).

The data may also be transmitted wirelessly.

The received echo curve, which is the transmission pulse reflected on one or more reflectors, typically has one or more maxima and/or minima, the electrical distances of which from the reception unit can be determined from the location of the corresponding maxima or minima.

These electrical distances correspond to the delays of the corresponding signal components of the pulse. The physical distances, that is to say the actual distances, can be calculated therefrom by taking account of the propagation speed of the signal.

The electrical distance corresponds to half of the distance which an electromagnetic wave covers in a vacuum in a particular time. By way of the speed of light, the electrical distance of an echo has a direct correspondence with the delay of a signal travelling to the reflection point and back to the fill level measurement device. The electrical distance does not take into account any influences of a medium which might lead to slower propagation of the electromagnetic waves. The concept of electrical distances is known to the person skilled in the art.

For determining the position of the fill level and the positions of other reflectors precisely, it is important that the maxima and/or minima in the echo curve (in the following known as echoes) can be identified clearly and assigned to a particular reflector.

This assignment is often difficult, because it is possible that two adjacent echoes may overlap and thus not be distinguished, or because the amplitude of an echo may be too low for the echo to be clearly recognised as such.

### SUMMARY OF THE INVENTION

An object of the invention is to improve the determination of fill levels.

In accordance with a first aspect of the invention, a delay-based fill level measurement device is specified which comprises a transmission unit for emitting a transmission signal, which is reflected on a filling material surface of a filling medium and at least on a second reflector. The delay-based fill level measurement device thus emits the transmission signal towards the filling material surface.

A reception unit (which may share some component groups with the transmission unit; in the case of fill level radar, the shared component group would be the transmission/reception antenna for example) is further provided, and is used to capture the reflected transmission signal (also known as the reception signal, reception pulse or echo curve). This reflected transmission signal is thus an echo curve, which in the case of a plurality of reflectors comprises a plurality of echoes. However, these echoes cannot always be recognised clearly in the echo curve, since the amplitude thereof is too low in some cases or because some of them partially overlap with one another.

The delay-based fill level measurement device further comprises an evaluation unit for carrying out a tracking method for grouping echoes, which in each case originate from identical reflectors (meaning that all echoes of one group originate from the same reflector), from echo curves captured at different times.

In the following, the tracking method is described again with reference to the drawings. Ultimately, the delay-based fill level measurement device receives echo curves at different times, resulting in a sequence of echo curves over time which mirror the development of the relationships in the container over time. The evaluation unit can now analyse each individual echo curve and determine the location of the maxima or minima.

The object of the tracking method is to assign each maximum or minimum to a reflector in the container or to classify it as an unassignable echo. If this assignment is carried out correctly, the development of the fill level over time and the development of the positions or electrical distances of the various other reflectors in the tank over time are obtained therefrom. The development of the positions or echo sites can subsequently be recorded in a diagram.

Assuming that there is a constant emptying or filling rate in the container, the individual measurement points (that is to say the electrical distances or positions of the reflectors which are calculated from the sequence of echo curves, including the position of the filling material surface) can be reproduced approximately using a straight line segment, as is shown for example in FIG. 2.

If the filling or emptying rate of the fill level changes, this leads to a kink in the calculated curve when describing tracks using straight line segments. In this case, there are thus two touching straight line segments having different gradients. Describing tracks using straight line segments or track segments is known to the person skilled in the art. Embodiments for this purpose are found for example in the disclosures of document US 20110231118 A1.

Since the electrical distances are taken into account for this purpose, and not the actual physical distances, the position of the base echo or of other stationary reflectors which are located below the filling material surface changes as the fill level increases or decreases. This is shown schematically in FIG. 8.

These touching straight line segments are referred to as tracks. Straight line segments are an example of a particularly memory-efficient representation of tracks. FIG. 8 shows three tracks T₁, T₂, T₃ of this type.

However, it may also further be possible to store the individual positions of the echoes grouped in a track directly in the memory. FIG. 10 shows these variant implementations. Further, other representations of a track may be used, for example mathematical forms of description such as polynomial representations or other mathematical forms of description.

Generally, one of these tracks describes the position of the filling material surface at various times, another track describes the position of the base echo, and a third track for example describes the position of a stationary reflector below the filling material level, the position of a separating layer between two different filling media or the probe end in the case of fill level measurement with guided waves.

The evaluation unit of the delay-based fill level measurement device is thus configured to determine a first track of a first group of echoes, which originate from a first reflector (for example the filling material surface, the container base etc.), and of a second track of a second group of echoes, which originate from a second reflector (in this case for example the container base, the filling material surface etc.), each track describing the delay of the corresponding transmission signal from the transmission unit to the reflector assigned to the track and back to the reception unit at the various times (that is to say at the various moments when the various transmission signals were emitted).

The evaluation unit is further configured so as to determine a linear relationship or linear correspondence or a functional correspondence between the first track and the second track, or more precisely between the positions of the echoes which are assigned to the first track and the positions of the echoes which are assigned to the second track.

How this functional correspondence is calculated is explained below, in particular with reference to FIGS. 1 to 4.

Since the electrical positions or electrical distances of the fixed reflectors below the filling material surface change in a manner corresponding to the position of the filling material surface itself, there is in mathematical terms a linear correspondence or linear relationship between every two tracks as regards the electrical distances or locations of the echoes grouped in the respective tracks, which can be estimated by using the various echo curves.

After determining the linear relationship between the first track and the second track, the evaluation unit can assign a first echo of a further echo curve to the first track. This further echo curve is for example received at a later moment than the echo curves in the sequence over time which are used to determine the linear relationship between the two tracks. This therefore involves a new measurement.

The evaluation unit can subsequently determine an expected position of a second echo of the further echo curve by calculating this expected position while taking account of the position of the first echo of the first track and the linear relationship.

Given knowledge of the linear correspondence between the two tracks and of a further measurement point (the position of an echo of a further echo curve), the expected position of the corresponding other echo can thus subsequently be calculated or estimated.

Once this has happened, the evaluation unit can subsequently establish, by way of the newly recorded echo curve, whether the expected position, calculated in this manner, of the second echo actually corresponds to an actual position of an echo of the further echo curve. In the present context, a particular expected position of the second echo may still correspond to an actual position of an echo of the further echo curve if the actual position of an echo of the further echo curve is within a predeterminable distance or within a predeterminable vicinity about the determined expected position. In other words, the echo curve is analysed and it is established whether an echo is actually located at the expected position or within a predeterminable vicinity of the expected position. If so, the second echo is actually assigned to the second track.

This is thus a type of plausibility check. On the one hand, the evaluation unit checks whether it can read an echo from the echo curve and, on the other hand, it calculates whether the position of this echo also corresponds to the mathematically expected position.

Thus, previously obtained findings of individual echoes of previously recorded echo curves (fill level echo, multiple echo, base echo etc.) are taken into account so as to improve the continued following of these echoes by tracking.

In this way, fill level echoes can be followed reliably during the filling and emptying of containers, irrespective of the presence of interfering multiple echoes, interference echoes and base echoes.

The invention makes it possible, irrespective of amplitude ratios or filling speeds, to follow the fill level echo reliably even in the presence of interference echoes, base echoes or multiple echoes.

Since the evaluation unit can determine the relationship between any two tracks or the relationship between the electrical distances or locations of any two tracks, this method can be used not only for the fill level echo, but also for the other echoes of the echo curve. In particular, the method makes it possible for all of the echoes captured in the echo curve to be tracked (that is to say, in principle, for any echo which is assignable to be actually assigned to its own track). This can result in a plurality of individual tracks, for which a linear relationship can be determined for each pair. In this way, in a newly recorded echo curve, it can be determined for each of these pairs whether the determined expected position of the echo of the respective second track corresponds to the corresponding track pair of an actual position of an echo of the new echo curve.

This ultimately means that the evaluation unit can decide, at the end of these calculations, which assignment of the individual echoes of the new echo curve is, in all probability, the correct one.

Of course, it is possible that this method may result in all of the possible assignments or at least some of the possible assignments being correct with the same probability. In this case, further considerations can be made use of so as to increase the probability of correct assignment of the individual echoes to the individual tracks. This may for example involve tracking methods which are already known.

Moreover, the further considerations may of course additionally be applied in every case.

In accordance with one embodiment of the invention, the evaluation unit is further configured to carry out steps (b) (determining the linear relationship between the first track and the second track), (c) (assigning a first echo of a further echo curve to the first track), (d) (determining an expected position of a second echo by calculation) and (e) (establishing whether the position determined in this manner actually corresponds to an actual position of the echo of a further echo curve and, if so, assigning the second echo to the second track) with the first track, the first echo and a third track.

The method is thus carried out again subsequently with a different track pairing.

In accordance with a further embodiment of the invention, the evaluation unit is further configured to carry out steps (b) to (e) for a third track, a third echo of the further echo curve, which is assigned to the third track, and to the second track.

In other words, the evaluation unit can thus carry out the method for all of the pairings of the various tracks, as disclosed above.

Determining the linear relationship between the first track and the second track may in particular mean determining the linear correspondence between the electrical distances of the echoes assigned to the first track and the electrical distances of the echoes assigned to the second track. Determining an expected position of a second echo by calculation may in particular mean calculating the expected electrical distance of a second echo.

In accordance with a further embodiment of the invention, the evaluation unit is configured to evaluate the determined expected position of the echo of the further echo curve as a match if it is established in step (e) that the determined expected position of the echo also corresponds to an actual position of an echo of the further echo curve.

If this method is carried out for all of the track pairs, the various numbers of matches can be compared with one another. In accordance with a further embodiment of the invention, the evaluation unit compares the number of matches after repeatedly carrying out steps (b) to (e), the first echo always being assigned to the first track until all further tracks of the echo curve have been taken into account, with the number of matches after carrying out steps (b) to (e), the first echo always being assigned to a track other than the first track until all further tracks of the echo curve have been taken into account.

In accordance with a further aspect of the invention, the evaluation unit is configured to compare the number of matches so as to evaluate the probability of correct assignment of the echoes to the corresponding tracks.

In accordance with a further aspect of the invention, a method is specified for carrying out a tracking method for grouping echoes, which originate from identical reflection points, of echo curves in a sequence over time, and for assigning an echo to a track. The method comprises the following steps:

(a) determining a first track of a first group of echoes which originate from a first reflector and a second track of a second group of echoes which originate from a second reflector, each track describing the delay of the corresponding transmission signal from the transmission unit to the reflector assigned to the track and back to the reception unit at the various times;

(b) determining a linear relationship between the first track and the second track;

(c) assigning a first echo of a further echo curve to the first track, the further echo curve having been received at a later moment than the echo curves in a sequence over time;

(d) determining an expected position of a second echo of the further echo curve by calculating the expected position by taking account of the position of the first echo of the first track and the linear relationship;

(e) establishing whether the expected position of the second echo determined in this manner actually corresponds to an actual position of an echo of the further echo curve and, if so, assigning the second echo to the second track.

In accordance with a further aspect of the invention, a processor for carrying out a tracking method as disclosed above and in the following for grouping echoes, which originate from identical reflection points, of echo curves in a sequence over time and for assigning an echo to a track.

In accordance with a further aspect of the invention, a computer-readable medium is specified, on which a program is stored, which when implemented on a processor of a delay-based fill level measurement device instructs the processor to carry out the method steps disclosed above and in the following.

In accordance with a further aspect of the invention, a program element is specified, which when implemented on a processor of a delay-based fill level measurement device instructs the processor to carry out the method steps disclosed above and in the following.

In the following, embodiments of the invention are described with reference to the drawings.

### BRIEF DESCRIPTION OF THE DRAWINGS:

FIG. 1 is a schematic drawing of the correspondence of track positions (electrical distances of reflectors) which are obtained from echo curves in a sequence over time, in accordance with one embodiment of the invention.

FIG. 2 shows the progressions over time of two tracks.

FIG. 3 is a schematic drawing of the linear relationship of track positions of two tracks in accordance with one embodiment of the invention.

FIG. 4 shows a method for reducing the combinatorics in fill level determination in accordance with one embodiment of the invention.

FIG. 5 shows a fill level measurement device comprising a filling material container in accordance with one embodiment of the invention.

FIG. 6 shows a further fill level measurement device comprising a filling material container in accordance with one embodiment of the invention.

FIG. 7A shows an echo curve received at a first time.

FIG. 7B shows an echo curve received at a second moment.

FIG. 8 shows the development of a plurality of tracks over time.

FIG. 9 shows the linear relationships between two tracks in each case.

FIG. 10 illustrates a tracking method.

FIG. 11 illustrates a further tracking method.

FIG. 12 shows a further example of a functional correspondence (linear relationship) between two tracks.

FIG. 13 shows a plurality of alternative assignments between existing tracks and discovered echoes.

FIG. 14 shows the determination of an expected position of an echo.

FIG. 15 shows the determination of an expected position of a different echo.

FIG. 16 is a flow chart of a method in accordance with an embodiment of the invention.

### DETAILED DESCRIPTION OF EMBODIMENTS

The drawings are schematic and not to scale. If like reference numerals are used in different drawings, they may denote like or similar elements. However, like or similar elements may also be denoted by different reference numerals.

In the following, a possible embodiment of the evaluation unit of a fill level measurement device is to be described. The received echo curve may initially undergo preparation. By way of selective digital evaluation of the signal, for example by way of digital filtering, it is more easily possible for a method for echo extraction to determine the significant signal components or minima or maxima from the echo curves.

For further processing, the extracted echoes may for example be stored in the form of a list. However, further possibilities other than storage in a list are also available for access to the data. The tracking function block assigns the echoes of an echo curve at moment tᵢ to the echoes of the following echo curve at moment tᵢ₊₁, the echoes assigned to a track having passed through the same physical reflection point and having covered the same distance (that is to say having been produced by reflection of the transmission signal on the same reflector).

Tracking methods are known. More detailed information may be found for example in WO 2009/037000 A2.

A key aspect of the invention is to place the development over time of two tracks, that is to say the development over time of the positions of two different physical reflection points or two reflections, in a relation with one another and to determine therefrom the parameters of a linear correspondence. Each track may consist of a sequence of position values which have been determined from the echoes of a plurality of echo curves established with an interval. Since in fill level measurement devices the distance from the sensor to the filling material is to be measured, the concept of distance is also used, alongside the concept of position.

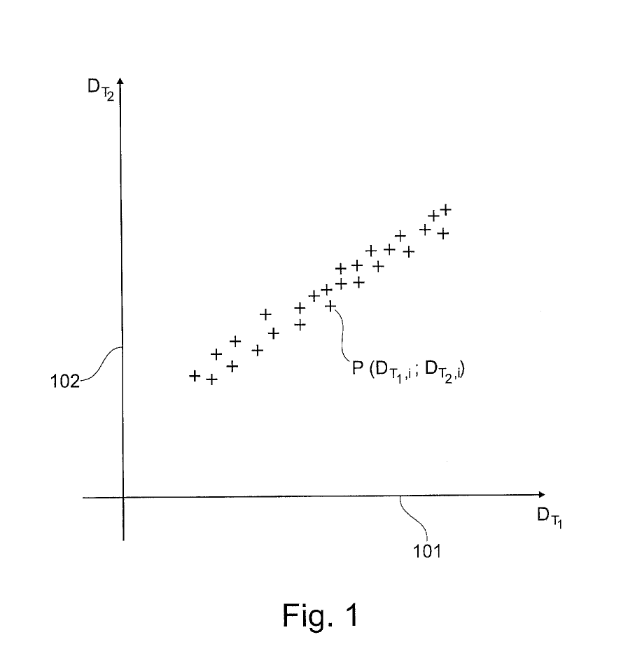

FIG. 1 is intended to clarify the situation regarding the relation between two tracks. The axis system shows a scatter plot which is formed from the distance pairs of the individual position values of two tracks. By way of example, the tracks are denoted track T₁ and track T₂. However, any other conceivable combination of two different tracks may be used.

Each distance pair is marked by a cross. The x-axis (101) comprises the distance D of track T₁, and the y-axis (102) comprises the distance D of track T₂. This arrangement is not necessarily required. Thus, the x-axis and y-axis could also be swapped over. The unit of measurement of the axis scaling is also irrelevant to the invention. Thus, the electrical distance D in this instance is thus merely exemplary. Temporal scaling of the position in accordance with the echo curve would also be possible. A distance pair is specially marked in FIG. 1 for more precise explanation. The distance pair P(D_{T1,i}; D_{T2,i}) describes a pair of values of two positions of track T₁ and track T₂ at the moment i at which the echo curve was generated. The other points in the diagram, which are not denoted more precisely, come from other echo curves which were captured by the sensor at different moments. A new echo curve which is generated by the sensor, which comes from a further signal processing run and the echoes of which have been assigned to the tracks, would add one additional point to the drawing.

The correspondence shown in FIG. 1 of the positions of the two tracks makes it clear that the positions of track T₁ and track T₂ can be brought into a relation. This means that track T₁ and track T₂ are in a functional correspondence. This is based on a straight line equation which describes the scatter plot. Mathematically, this correspondence can be described as follows:

D_{T2,k}=a₁·D_{T1,k}+a₀+eₖ (1.1)

D_{T2,k} is the position of track T₂ of the measurement at moment k.

D_{T1,k} is the position of track T₁ of the measurement at moment k.

a₀ and a₁ are the parameters of a straight line, and describe the linear correspondence between the positions of track T₁ and track T₂.

eₖ is the error in the correspondence for the measurement at moment k.

The parameter a₁ of the function is dimensionless, whilst a₀ has the same unit of measurement as D_{T2,k} and D_{T1,k}. eₖ has the same unit of measurement as D_{T2,k} and D_{T1,k}. It is necessary to postulate an error in the specified correspondence, since in this way the errors in the model can be reproduced in combination. The parameters a₁ and a₀ are dependent on the given properties of the measurement point at which the sensor is used. In addition, the parameters are dependent on the progression of the tracks which are being brought into a relation with one another.

Formula (1.1) is merely one feature of the correspondence. Naturally, it can be applied to each track and in particular to each pair of tracks, and does not necessarily require track T₁ and track T₂ as a basis. However, the values of the parameters a₁ and a₀ are then different from the correspondence between track T₁ and track T₂.

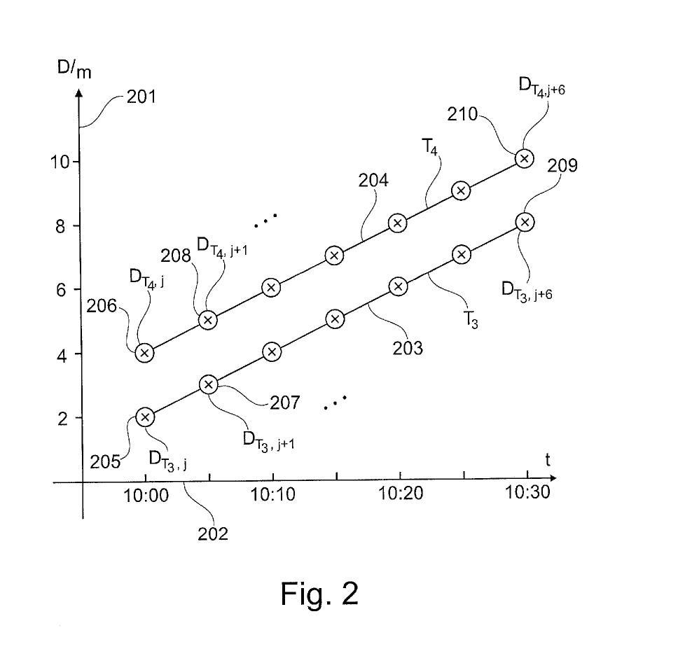

FIG. 2 shows the exemplary progression of two tracks (T₃ 203 and T₄ 204) over time. The y-axis 201 represents the distance in metres and the x-axis 202 represents the moment t at which the fill level measurement device has captured the positions of the respective tracks. The supporting points 205, 207, 209 . . . and 206, 208, 210 . . . of the tracks 203, 204 resulting from the echo positions of the echo curves at the respective moment j are each marked with an x.

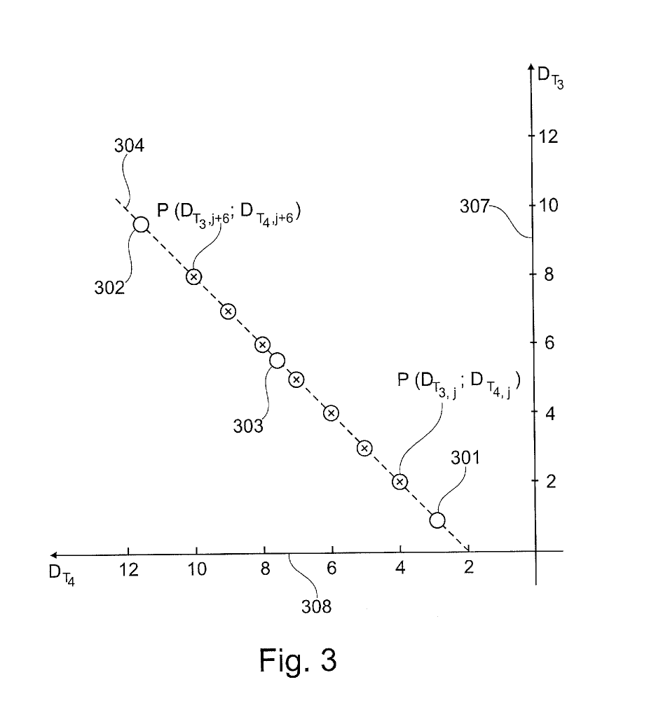

If the supporting points from FIG. 2 are transferred into a diagram, which like FIG. 1 illustrates the relation between the two tracks, the diagram of FIG. 3 is obtained. The y-axis 307 in this case comprises the positions of track T₃ and the x-axis 308 in this case comprises the positions of track T₄. In addition, the linear correspondence 304 between the two tracks is drawn in in the form of a broken line. It can now be seen that, aside from the supporting points in FIG. 3, further statements about the correspondence of the two tracks can also be made. The correspondence can be applied both for positions 303, which are located between the supporting points, and for positions 302 and 301, which are located alongside the supporting points. This further means that if the position of one track is known the position of the other track can be predicted. This prediction can be reversed. In the example of FIG. 3, this means that the position of track T₄ can be predicted from the position of track T₃ and vice versa. In addition, not only can a prediction be made, but an estimate of the position of a track can also be specified if it has not been possible to determine the position of the track because of unfavourable signal ratios.

Determining the Parameters a₀ and a₁

The parameters a₀ and a₁ may for example be determined automatically by a relation regression analysis function block integrated into the fill level measurement device. As a result of unavoidable errors in the measurement-related capture of the positions of individual echoes or tracks, what is known as estimation of the parameters is advantageous, and minimises the errors in determining the parameters. The estimation itself may take place in various ways. It is possible to apply conventional parameter estimation methods, such as LS estimation. LS estimations are disclosed explicitly in the literature and are known to the person skilled in the art. An estimation may for example be configured as follows:

D_{T2}=â1·D_{T1}+â₀

D_{T2} is the position of track T₂

D_{T1} is the position of track T₁

â₀ and â₁ are the estimated parameters of a straight line, and describe the linear correspondence between the positions of track T₁ and track T₂.

So as not to have to keep the position pairs continuously in the memory, the aforementioned methods may also be implemented recursively. The estimation may initially be erroneous, but improves with an increasing number of pairs of values. It is of course necessary initially to determine the parameters, before a prediction as to the current position of one track can be made from the position of the other track.

The disclosed invention can usefully be expanded. The echo curve often exhibits a large number of echoes, and this leads to a large number of tracks. In the disclosed method, in the general case, all of the tracks are placed in relation with one another. This means that from each individual track a prediction can be made directly about the location of each other track. The number A of functional correspondences to be made can be calculated as a function of the number N of tracks, using the formula

A=N·(N−1)/2

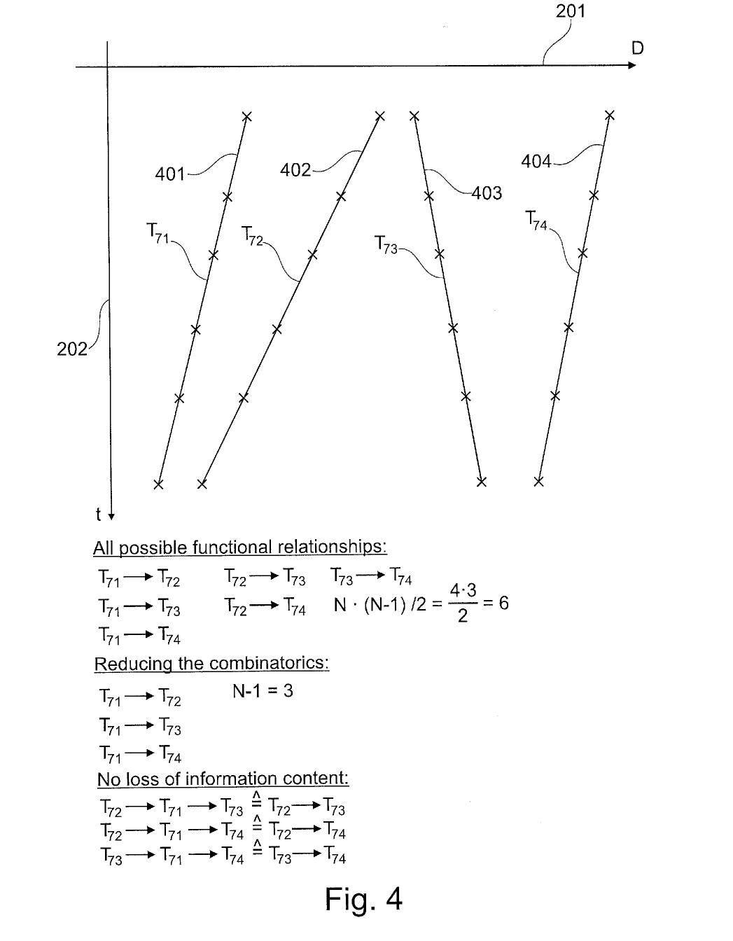

So, if four tracks are being followed, six correspondences have to be produced, calculated, maintained and stored. An expansion of the invention results from selectively reducing the combinatorics. FIG. 4 shows the complete listing in the case of four different tracks. The functional correspondences are shown by an arrow. The direction of the arrow is merely exemplary, since the correspondence can also be reversed. For example, if the correspondence T₇₁→T₇₂ is known, the correspondence T₇₂→T₇₁ can also be calculated by taking the inverse function. Further, FIG. 4 shows a possibility for reducing the combinatorics without reducing the predictive power of the invention. For example, the reduction has been carried out using track T₇₁. The correspondences between T₇₂ and T₇₃, T₇₂ and T₇₄, and T₇₃ and T₇₄ can be calculated from the correspondences between T₇₁ and T₇₂, T₇₁ and T₇₃, and T₇₁ and T₇₄. It is thus only necessary to store and expand

A=N−1

functional correspondences (therefore three in FIG. 4). The reduction assumes that a track has to be selected as a starting point for the reduction. This track could be referred to as an intermediate track. In the example of FIG. 4, this is track T₇₁. Naturally, any other track could also be selected as the intermediate track for the reduction. The fact that no information content is lost is demonstrated by the calculation chain of FIG. 4. For example, the correspondence between T₇₂→T₇₃ can be determined from the two correspondences T₇₁→T₇₂ and T₇₁→T₇₃. For this purpose, the inverse function T₇₁←T₇₂ of T₇₁→T₇₂ has to be taken. Subsequently, the expanded correspondence T₇₂→T₇₁→T₇₃ can be set up and the location of track T₇₃ can be determined from track T₇₂ without having estimated in advance the parameters of the functional expression for the correspondence T₇₂→T₇₃. This results in advantages in performance, since the estimation of the parameters is found to be computationally intensive. Memory space is also saved.

A key aspect of the disclosed method involves the estimation of the parameters of a target function, which subsequently describes the correspondence in position between two tracks. If the parameters of the target function have been determined sufficiently well during the operation of the fill level measurement device, from the position of one track a conclusion can be drawn as to the position of another track. Since the parameters are dependent on the place of measurement (place of installation, feed pipe, flange, container base, container floor, filling material, fixtures in the container), parameterisation cannot take place during production.

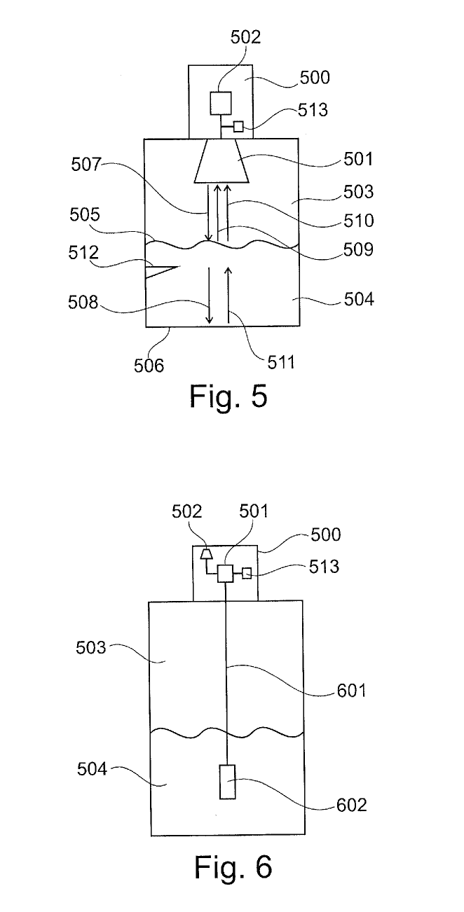

FIG. 5 shows a delay-based fill level measurement device 500, which is installed on or in a container. The fill level measurement device 500 is for example a fill level radar or an ultrasound device. This delay-based fill level measurement device 500 emits freely radiating waves, for example in the form of pulses 507, towards the filling material surface 505. In the case of fill level radar, an antenna 501 is provided for this purpose, for example in the form of a horn antenna. This transmission signal or the transmission pulse 507 is generated by means of a signal generator unit 513 and emitted via the transmission/reception unit 501. The emitted transmission signal 507 is subsequently incident on the filling material surface 505 of the filling material 504 which is located in the container. Beforehand, it passes through the medium located above the filling material surface 505, for example the container atmosphere.

A component of the transmission signal 507 is subsequently reflected on the filling material surface and moves back to the transmission/reception unit 501 as an echo 509. Another component of the transmission signal 507 enters the filling medium 504 and moves to the base 506 of the container (see signal component 508), where it is subsequently reflected and moves back towards the transmission/reception unit 501 as what is known as a base echo 511. Part of this base echo is reflected back again (on the filling material surface 505). However, another part of this base echo 510 penetrates the filling material surface 505 and can subsequently be received by the transmission/reception unit 501 and passed to the evaluation unit 502.

Part of the transmission signal 507 may also be reflected on other reflectors. A projection 512 attached to the container wall is shown as an example of this, and is located below the filling material surface.

FIG. 6 shows a further example of a delay-based fill level measurement device 500 installed on a container. This is a TDR fill level measurement device, which operates using guided waves. These may be guided microwaves or other wave-like transmission signals, which are guided along a wire 601 or else for example in the inside of a hollow guide, towards the filling material surface and also in part into the filling material. At the end of the wire 601, there is for example a weight 602 for tensioning the wire.

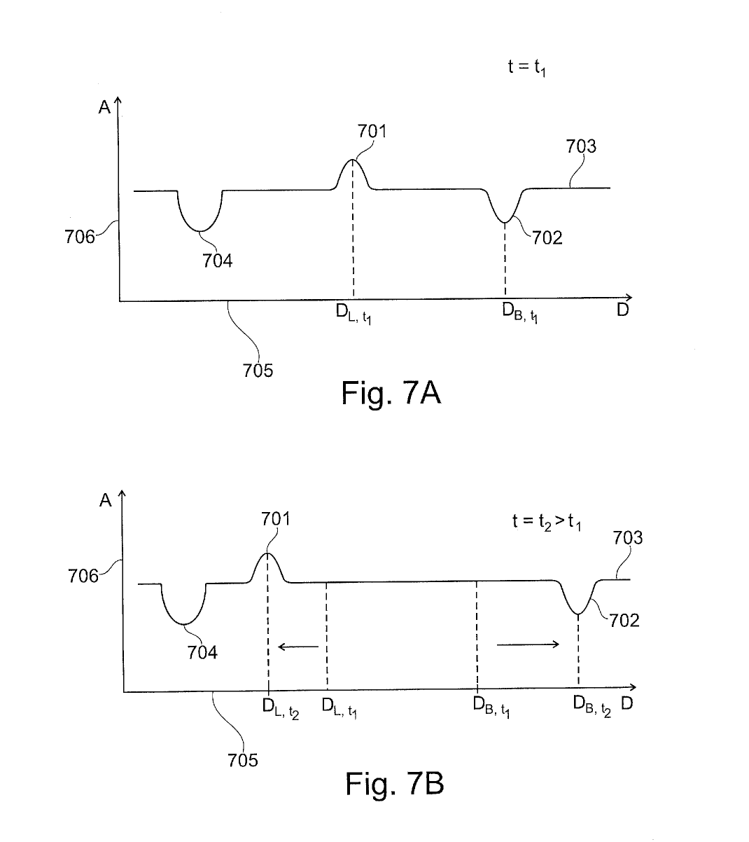

FIG. 7A shows an example of an echo curve 703 which is recorded in the evaluation unit. The echo curve 703 has two minima 702, 704 and one maximum 701.

At this point, it should be noted that the horizontal axis 705 represents the electrical distance (which corresponds to the delay of the individual portions of the echo curve 703) and the vertical axis 706 represents the amplitude of the individual portions of the echo curve 703.

The maximum 701 is for example the echo reflected on the filling material surface, and the minimum 702 is for example the echo reflected at the probe end of the probe 601, 602 of FIG. 6 or the echo reflected on the container base 506 of FIG. 5.

This echo curve is received at a moment t₁.

FIG. 7B shows a corresponding echo curve which was received at a subsequent moment t₂. As can be seen from this curve, both the filling material echo 701 and the probe end or base echo 702 have been displaced, but in opposite directions. This is because the probe end echo or base echo is located below the filling material surface.

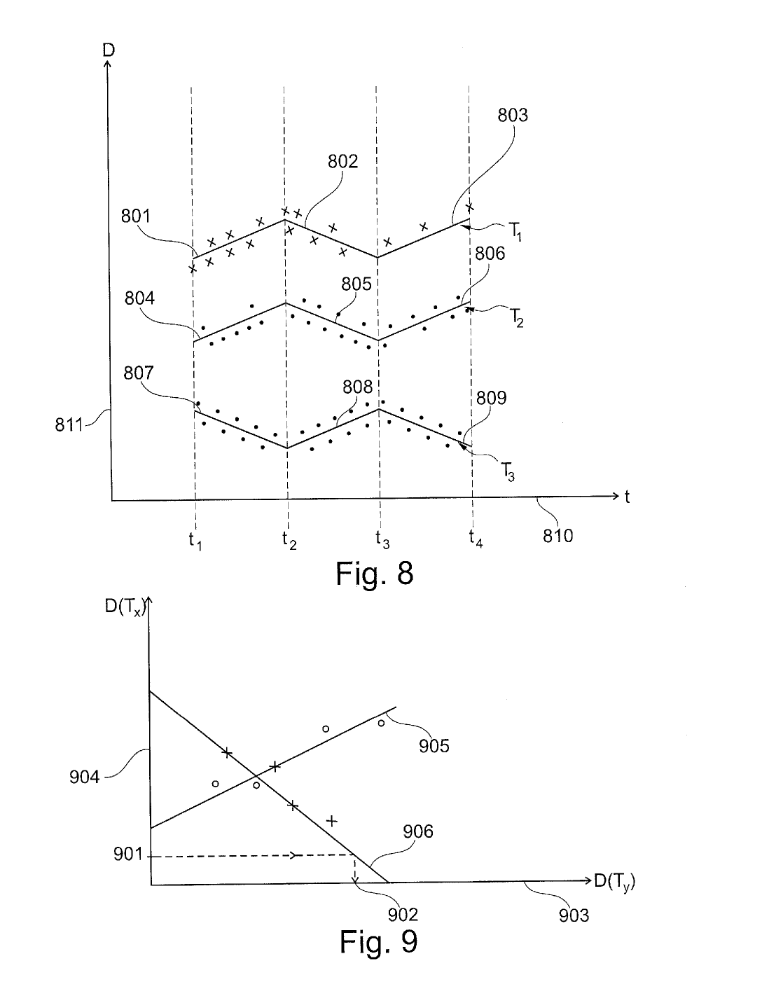

If the evaluation unit now establishes that the echo 701 represents echoes which originate from an identical reflector (in this case from the filling material surface), and if it establishes that the echoes 702 likewise originate from another identical reflector (container base or probe end), the echoes 701 can be combined into a first group and the echoes 702 can be combined into a second group. If a plurality of echo curves are received at different moments, the electrical distances of the individual echoes can be represented approximately by touching straight line segments. This is shown in FIG. 8. The horizontal axis 810 denotes the moments tᵢ at which the individual echo curves were measured and the vertical axis 811 denotes the electrical distance which the various echoes of the individual echo curves have covered.

The first track T₁ consists of three straight line segments 801, 802, 803, which each have a different gradient according to the rate at which the container is filled or emptied. Straight line segment 801 describes the container being filled between moments t₁ and t₂, segment 802 describes emptying between moments t₂ and t₃, and segment 803 describes filling again between moments t₃ and t₄.

As is symbolised by the crosses around the three straight line segments 801, 802, 803, a large number of measurements (echo curve captures) have been taken, in such a way that the three straight line segments 801 to 803 can be determined sufficiently precisely.

The received echo curves also comprise two further groups of echoes, the electrical distances of which are approximated by the straight line segments 804, 805, 806 and 807, 808, 809 respectively.

As can be seen from FIG. 8, the kinks in the three tracks T₁ to T₃ are each located at the same moments t₂, t₃ and t₄.

Subsequently, any two of the tracks can be placed in a relationship with one another so as to determine the functional correspondence between the individual tracks. If two pairs of tracks are taken in each case, this results in two approximate straight lines 905, 906 (see FIG. 9). In this case, the horizontal axis 903 denotes the electrical distance of the echoes of a first echo group (that is to say of a first track Ty) and the vertical axis 904 denotes the electrical distance of the echoes of a second echo group (that is to say of a second track Tx). Experts often use the term “track position” in this connection. As described above, this refers to the corresponding electrical distance which a particular echo of a particular echo curve has covered on its path to the reception unit.

By determining the functional correspondence (905, 906), the tracking of the echo can be improved.

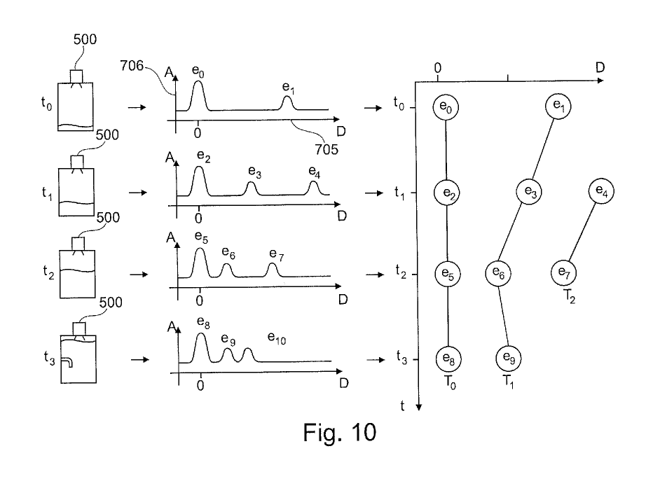

In particular, this makes it possible to solve the problem which occurs when two groups of echoes in an echo curve come very close, in such a way that the gating regions thereof overlap. A case of this type is shown for example in FIG. 10 at moment t=t₃.

The gating region of a group of echoes or of a track may be a predeterminable tolerance region for the location of an echo. Often, in practice, a fixed region about the most recently captured position or electrical distance of an echo or track is used as the gating region. The use of gating regions is known to the person skilled in the art, and is disclosed for example in WO 2009/037000 A2.

FIG. 10 shows how the echo curves appear at four different times t₀, t₁, t₂ and t₃. In the present example, track T₁ is decided on the basis of the spatial vicinity to a continuation with echo e₁₀. However, in physical terms this represents the continuation of the multiple echo track T₂. Incorrect assignments of this type generally cannot be prevented using known methods.

Multiple echoes result from multiple reflection of the transmission signal on the container floor and the filling medium (for example: measurement device→filling material surface→container floor→filling material surface→measurement device). They are known to the person skilled in the art from various publications.

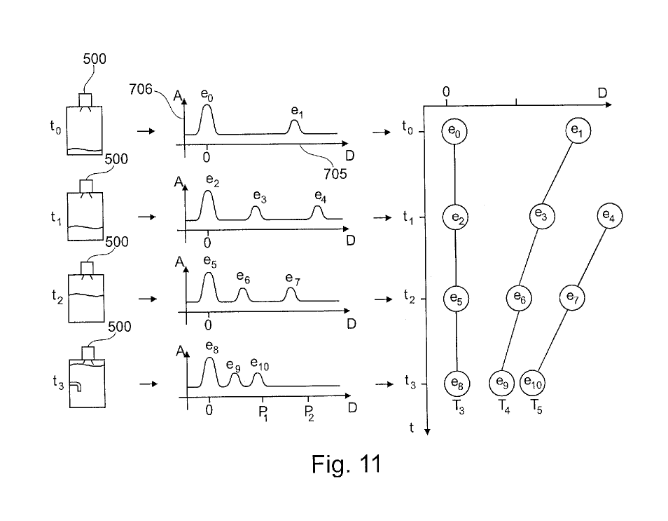

By using the method according to the invention, behaviour corresponding to FIG. 11 can be achieved. This shows the same sequence of echo curves. The antenna bell echo (e0, e2, e5, e8), the actual filling material echo (e1, e3, e6, e9) and the first multiple echo of the filling material reflection (e4, e7, e10) can be seen.

The improved behaviour is achieved by taking account of the functional correspondence (linear relationship) between track T₄ and track T₅.

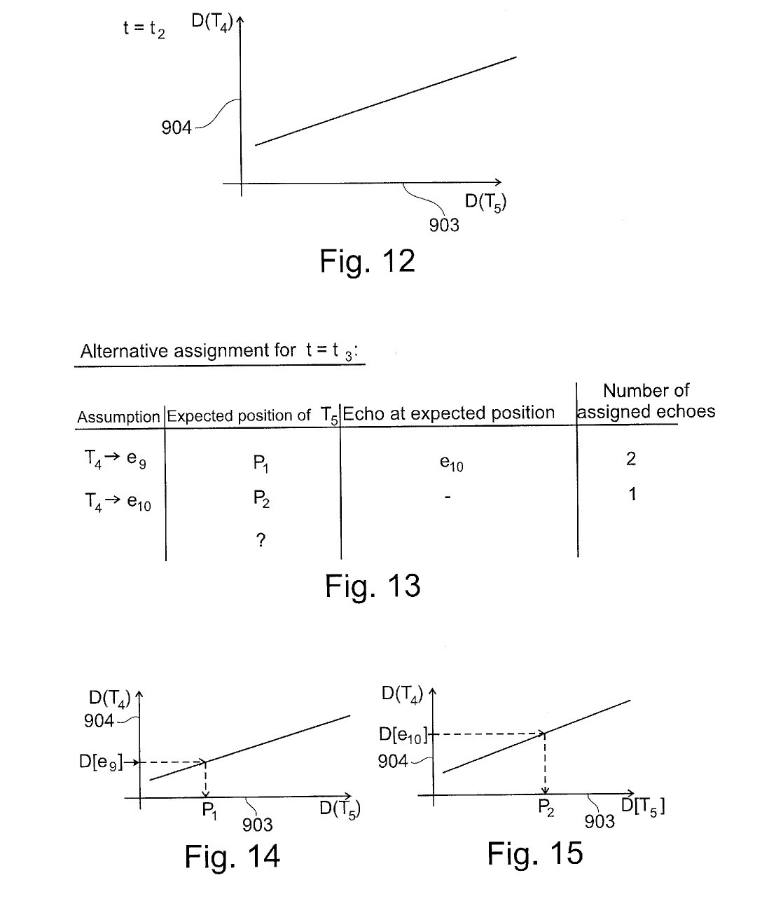

FIG. 12 shows the linear relationship between tracks T₄ and T₅, as detected for example at t=t₂ by the fill level measurement device.

The evaluation unit in the fill level measurement device comprises a tracking means and, as shown in FIG. 13, forms a plurality of alternative assignments between the existing tracks (possibly having existed for several measurement cycles) and the discovered echoes of the echo curve currently being captured.

As a first assumption, T₄ is hypothetically continued with echo e9. The tracking method subsequently checks, for all pre-existing tracks (filling material echo track, multiple echo track, base echo track and/or probe end track etc.), whether there is a functional correspondence with the track currently to be continued. If there is a functional correspondence of this type, it is then determined at which position the pre-existing track would have to appear, as shown in FIG. 14. As explained several times above, the “position of a track” at a particular moment is the electrical distance which the echo of the echo curve recorded for this moment has covered (or in other words the position of the echo at this moment).

In this case, track T₅ has to appear at position P1 (cf. FIG. 11). Echo e10 is located at position P1 (more precisely: in the vicinity of position P1), and therefore it follows causally (on the basis of the hypothesis of a continuation of track T₄ with echo e9) that track T₅ has to be assigned to echo e10. The number of assignable echoes is thus equal to 2 in the present case.

As a second assumption, T₄ is hypothetically continued with echo e10. In accordance with FIG. 15, the causally following position of track T₅ results as P2. There is no current echo at position P2 (cf. FIG. 11), and T₅ therefore cannot be continued using this assumption. The number of assignable echoes is thus lower by one (1).

The most appropriate assignment results from the first hypothesis, since the number of assignable echoes is greatest in this case. This criterion is based on the physical fact that, under normal circumstances, echoes of known reflection points do not randomly disappear, but can be discovered again in a corresponding position (as long as they do not descend into noise etc.).

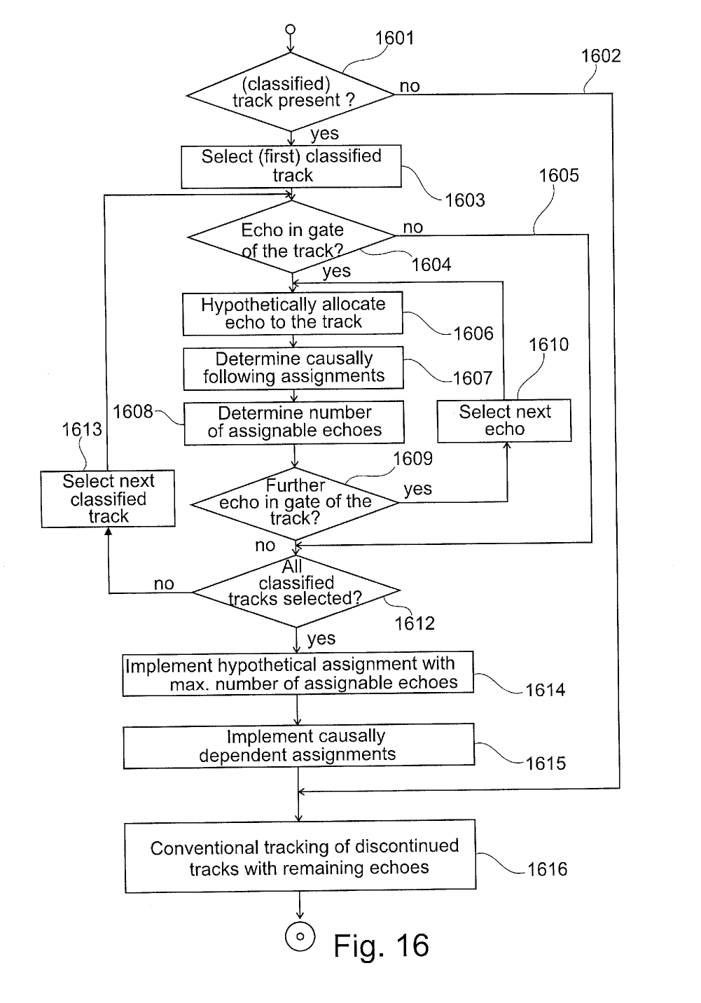

FIG. 16 shows a complete flow chart of the method. It should be noted that classified tracks mean tracks which group echoes selected from the group of echo types consisting of filling material echo, base echo, multiple echo or interference echo, covered interference echo or probe end echo. Further, a multiple echo of a base echo can also be used. In the present context of the invention, base echo, which is better known from the field of freely radiating microwaves, can be used synonymously with the terms “probe end echo” or “cable end echo”, which are known from the field of guided microwaves.

In step 1601, it is established whether a track is present. Classification of the track is not necessary, but can additionally be taken into account in another embodiment. If no track is present, the method jumps ahead to the final step, in which conventional tracking of the discontinued track (or even of all tracks) with the remaining echoes (or all echoes) takes place.

If a track is present, the first track is selected (step 1603). In step 1604, it is subsequently decided whether the echo is in the gate of the track, that is to say whether there is an echo close enough to the last recognised location of the track which is suitable for being assigned to this track. If this is not the case, in step 1605 the method jumps to step 1612.

If it is in fact the case, the echo is hypothetically allocated to this track in step 1606 (forming a first hypothetical assignment), and in step 1607 at least one causally following assignment of a further echo to one of the further tracks is determined (cf. FIG. 14, 15). In step 1608, the number of assignable echoes which would result from the first hypothetical assignment is determined, and in step 1609, it is determined whether there is a further echo in the gate of the track. If this is the case, a further hypothetical assignment of an echo to the first track can be analysed, and the method jumps to step 1610. In this method step, the next echo in the gate of the track is selected, whereupon it forms the starting point, in step 1606, of a further hypothetical assignment of an echo to the track. If there is no further echo in the gate of the first track, the method jumps to step 1612, in which it is established whether all of the tracks have been selected. If this is not the case, the method jumps to step 1613, in which the next (classified or unclassified) track is selected, whereupon the method continues with step 1604.

If it is in fact is the case (that is to say if all of the tracks have been processed), in step 1614 the assignment of an echo to the corresponding track, which was previously only hypothetical, is implemented, the hypothetical implementation which corresponds to the maximum number of assignable echoes being implemented. In step 1615, the resulting causally dependent assignments are implemented, and in the final step 1616, conventional tracking of discontinued tracks can be carried out with remaining echoes.

For completeness, it should be noted that “comprising” and “having” do not exclude the possibility of other elements or steps, and “an” or “a” does not exclude the possibility of a plurality. It should further be noted that features or steps which were disclosed with reference to one of the above embodiments may also be used in combination with other features or steps or other above-disclosed embodiments. Reference numerals in the claims should not be considered as limiting.

1-10. (canceled)

11. A delay-based fill level measurement device, comprising:
a transmission unit emitting a transmission signal which is reflected on a filling material surface of a filling medium and at least on a second reflector;
a reception unit capturing the reflected transmission signal which is an echo curve comprising a plurality of echoes; and
an evaluation unit performing a tracking method for grouping echoes, which in each case originate from identical reflectors, from echo curves captured at different times, the evaluation unit being configured to carry out the following steps:
(a) determining a first track of a first group of echoes which originate from a first reflector and a second track of a second group of echoes which originate from a second reflector, each track describing the delay of the corresponding transmission signal from the transmission unit to the reflector assigned to the track and back to the reception unit at the various times;
(b) determining a linear relationship between the first track and the second track;
(c) assigning a first echo of a further echo curve to the first track, the further echo curve having been captured at a later moment than the echo curves in a sequence over time;
(d) determining an expected position of a second echo of the further echo curve by calculating the expected position by taking account of the position of the first echo of the first track and the linear relationship; and
(e) establishing whether the expected position of the second echo determined in this manner actually corresponds to an actual position of an echo of the further echo curve and, if so, assigning the second echo to the second track.

12. The device according to claim 11, wherein the evaluation unit is further configured to carry out steps (b) to (e) for the first track, the first echo and a third track.

13. The device according to claim, wherein the evaluation unit is further configured to carry out steps (b) to (e) for a third track, a third echo of the further echo curve, which is assigned to the third track, and the second track.

14. The device according to claim 11, wherein determined expected position is evaluated as a match if it is established in step (e) that the determined expected position of the echo actually corresponds to an actual position of an echo of the further echo curve.

15. The device according to claim 14, wherein the evaluation unit is further configured to compare (I) a number of matches after repeatedly carrying out steps (b) to (e), the first echo always being assigned to the first track until all further tracks of the echo curve have been taken into account, with (II) a number of matches after repeatedly carrying out steps (b) to (e), the first echo always being assigned to a track other than the first track until all further tracks of the echo curve have been taken into account.

16. The device according to claim 15, wherein, wherein the evaluation unit is further configured to compare the numbers of matches so as to evaluate the probability of correct assignment of the echoes to the corresponding tracks.

17. A method for carrying out a tracking method for (i) grouping echoes, which originate from identical reflection points, of echo curves in a sequence over time and (ii) assigning an echo to a track, comprising the following steps:
(a) determining a first track of a first group of echoes which originate from a first reflector and a second track of a second group of echoes which originate from a second reflector, each track describing the delay of the corresponding transmission signal from the transmission unit to the reflector assigned to the track and back to the reception unit at the various times;
(b) determining a linear relationship between the first track and the second track;
(c) assigning a first echo of a further echo curve to the first track, the further echo curve having been captured at a later moment than the echo curves in a sequence over time;
(d) determining an expected position of a second echo of the further echo curve by calculating the expected position by taking account of the position of the first echo of the first track and the linear relationship; and
(e) establishing whether the expected position of the second echo determined in this manner actually corresponds to an actual position of an echo of the further echo curve and, if so, assigning the second echo to the second track.

18. A processor for (i) carrying out a tracking method for grouping echoes, which originate from identical reflection points, of echo curves in a sequence over time and (ii) assigning an echo to a track, the method comprising the steps of claim 17.

19. A computer-readable medium, on which a program is stored, which when implemented on a processor of a delay-based fill level measurement device instructs the processor to carry out the method of claim 17.

20. A program element, which when implemented on a processor of a delay-based fill level measurement device instructs the processor to carry out the steps of claim 17.
